(19) United States
(12) Patent Application Publication
(10) Pub. No.: US 2011/0196853 A1
(43) Pub. Date: Aug. 11, 2011

(54) SYSTEM, METHOD, AND APPARATUS FOR GENERATING A SCRIPT TO PERFORM A TASK AT A TARGET WEB INTERFACE INSTANCE

(75) Inventors: Jeffrey P. Bigham, Cambridge, MA (US); Clemens Drews, San Jose, CA (US); Tessa A. Lau, Mountain View, CA (US); Ian A. R. Li, Pittsburgh, PA (US); Jeffrey W. Nichols, San Jose, CA (US)

(73) Assignee: INTERNATIONAL BUSINESS MACHINES CORPORATION, Armonk, NY (US)

(21) Appl. No.: 12/702,152

(22) Filed: Feb. 8, 2010

(51) Int. Cl. G06F 15/18; G06F 17/30; G06F 7/10

(52) U.S. Cl. 707/706; 706/12; 707/769; 707/E17.108

(57) ABSTRACT

A computer-implemented method for automatically generating a script for a target web interface instance. Embodiments include receiving a task description of a task to be completed on a target web interface instance. The computer-implemented method also includes repeating steps until the task is completed. The repeating steps include determining from the target web interface instance a plurality of actions that may be performed on the target web interface instance and using the task description, predicting which action of the plurality of actions from the target web interface instance is an action most likely to be selected. The repeating steps also include performing the action most likely to be selected, thus proceeding to a first web interface instance and setting the first web interface instance as the target web interface instance.

### BACKGROUND

Many websites exist that provide similar functionality. For example, most airline websites provide the means to book a flight, check in for an existing flight, or view the status of a flight. This process is usually similar, using similar buttons and field names (e.g., “the flight status link”, your “departure city”, the “arrival date”) to accomplish the same goal on the different vendors' sites. However, because of subtle differences between the layout and design of the websites, documentation or scripts written for one website may not work unchanged with the other websites.

A script that operates on a particular website explains how to do a task on the website through a sequence of actions, such as clicking on links, entering text into fields, and pressing buttons. A script that is recorded on one website usually cannot be used unchanged on another website without modification, because of differences in how targets are labeled (e.g., a “Check in” button on one airline website might be labeled “Flight Check-in” on another airline website).

In addition, websites are regularly updated and modified. When a website is modified, a script that operated on the website before the modification may not perform the required tasks on the modified website.

The only known solution to these problems is for human editorial staff to manually update scripts for other or modified website(s). This process may require a significant amount of time or resources.

### SUMMARY

Embodiments of a computer-implemented method for automatically generating a script for a target web interface instance are described. In one embodiment, the computer-implemented method includes receiving a task description of a task to be completed on a target web interface instance. The computer-implemented method also includes repeating steps until the task is completed. The repeating steps include determining from the target web interface instance actions that may be performed on the target web interface instance and using the task description, predicting which action of the actions from the target web interface instance is an action most likely to be selected. The repeating steps also include performing the action most likely to be selected, thus proceeding to a first web interface instance and setting the first web interface instance as the target web interface instance. Other embodiments of the computer-implemented method are also described.

Embodiments of a computer program product for automatically generating a script for a target web interface instance are described. The computer program product includes a computer useable storage medium to store a computer readable program that, when executed on a computer, causes the computer to perform operations, including receiving a task description of a task to be completed on a target web interface instance. The operations also include repeating steps until the task is completed. The repeating steps include determining from the target web interface instance a plurality of actions that may be performed on the target web interface instance and pairing the task description with a description of a script in a repository of existing scripts. The repeating steps also include pairing an action from the script with an action that may be performed on the target web interface instance and assigning the paired action that may be performed on the target web interface instance as an action most likely to be selected. The repeating steps also include performing the action most likely to be selected, thus proceeding to a first web interface instance, and setting the first web interface instance as the target web interface instance. Other embodiments of the computer program product are also described.

Embodiments of a system are also described. In one embodiment, the system includes a script repository, a task description receiver, a script generator, and an action performer. The script repository stores a plurality of scripts, each script to perform a task on a web interface instance. The task description receiver receives a task description of a task to be performed. The script generator determines a target web interface instance for the task and repeats steps until the task is completed. The repeating steps include determining from the target web interface instance a plurality of actions that may be performed on the target web interface instance and, using the task description, predicting which action of the plurality of actions from the target web interface instance is most likely to be selected. The repeating steps also include submitting the action to the action performer to perform the action most likely to be selected, thus proceeding to a first web interface instance, and setting the first web interface instance as the target web interface instance. The action performer performs an action submitted by the script generator. Other embodiments of the system are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a system for modifying a script that operates on one web interface instance to operate on another web interface instance.

FIG. 2 depicts a schematic diagram of one embodiment of the script manager of FIG. 1.

FIG. 3 depicts a schematic diagram of one embodiment of the action performer of FIG. 1.

FIG. 4 depicts a schematic diagram of one embodiment of the likely action selector of FIG. 2.

FIG. 5 depicts a schematic diagram of one embodiment of a system for determining likely actions on a target web interface instance.

FIG. 6 is a flow chart diagram depicting one embodiment of a method for modifying a script that operates on one web interface instance to operate on another web interface instance.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

In some embodiments, a script manager automatically translates a script or documentation that operates on one web interface instance to operate on one or more related web interface instances. By examining the original script text and consulting the possible options on the target web interface instance(s), the script manager automatically infers the corresponding steps to perform on the target web interface instances. The original script is automatically translated into a series of commands that work on the target web interface instance(s) without any human editing required. This automated conversion process saves time and effort of converting the documentation/scripts from one web interface instance to another. As used herein, a web interface instance may include any type of online interface mechanism. For example, a web interface instance may include a website, a web page, an online application, an embedded program, or any other online interface.

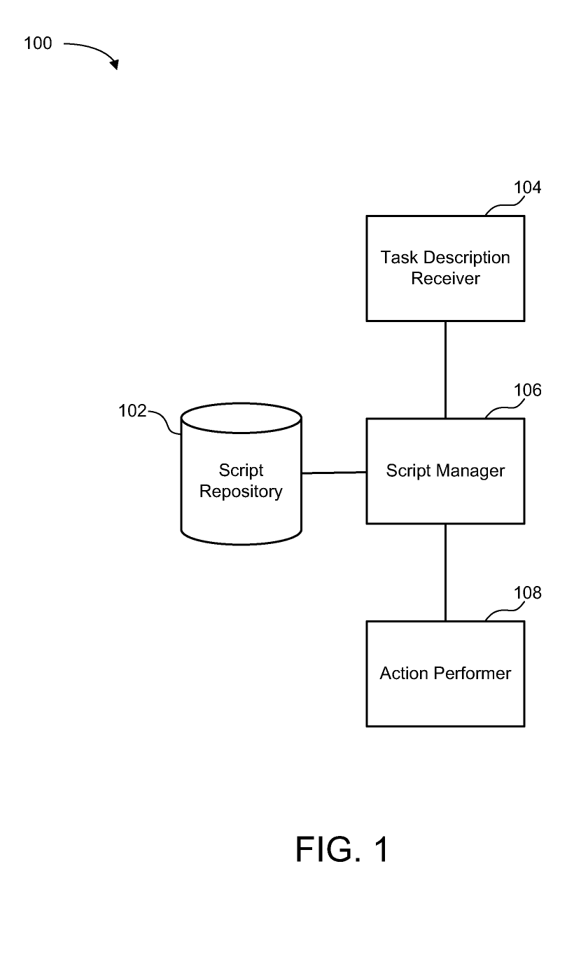

FIG. 1 depicts a schematic diagram of one embodiment of a system 100 for modifying a script that operates on one web interface instance to operate on another web interface instance. The system 100 includes a script repository 102, a task description receiver 104, a script manager 106, and an action performer 108. The system 100 receives a request to perform a web-based task, selects a script originally designed to operate on a different web interface instance, and attempts to modify the script to perform the task on a web interface instance.

The script repository 102, in one embodiment, contains one or more scripts. Each script in the script repository 102 includes instructions to perform a task on a web interface instance. A script in the script repository 102 may include additional information, such as metadata, that describes the script. For example, the script may include metadata that describes the web interface instance associated with the script, the author of the script, the date the script was created, modified, and/or executed, a description of the task that the script automates, and/or the type or category of task the script automates.

In certain embodiments, the scripts stored in the script repository 102 are written in a natural language. The natural language scripts may be in a form that a non-programmer can easily understand. The natural language scripts may also be easily modified by a non-programmer to perform additional and/or different tasks.

The script repository 102 may operate on any type of computer equipment capable of storing scripts. For example, the script repository 102 may operate on a database. The script repository 102, in one embodiment, stores scripts on computer storage, such as a hard drive or hard drives.

The task description receiver 104, in one embodiment, receives a task description of a task to be performed. In some embodiments, the task description receiver 104 receives a target web interface instance on which the task is to be performed. In an alternative embodiment, the task description receiver 104 does not receive a target web interface instance, and the target web interface instance is automatically determined by an element of the system 100.

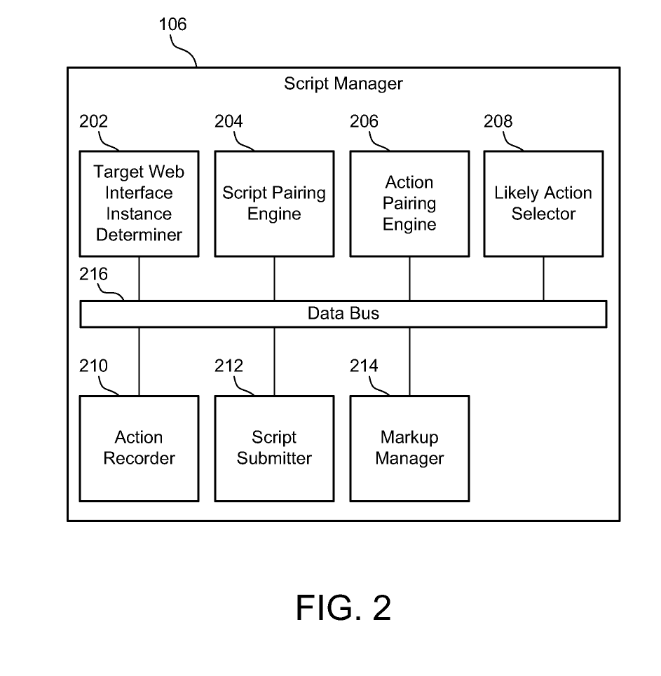

In some embodiments, the script manager 106 receives information from the task description receiver 104, accesses a script in the script repository 102, and generates a script to perform one or more actions on a target web interface instance. In some embodiments, the script manager 106 accesses one or more scripts from the script repository 102 to generate a script to perform one or more actions on a target web interface instance. The script manager is described in greater detail in relation to FIG. 2.

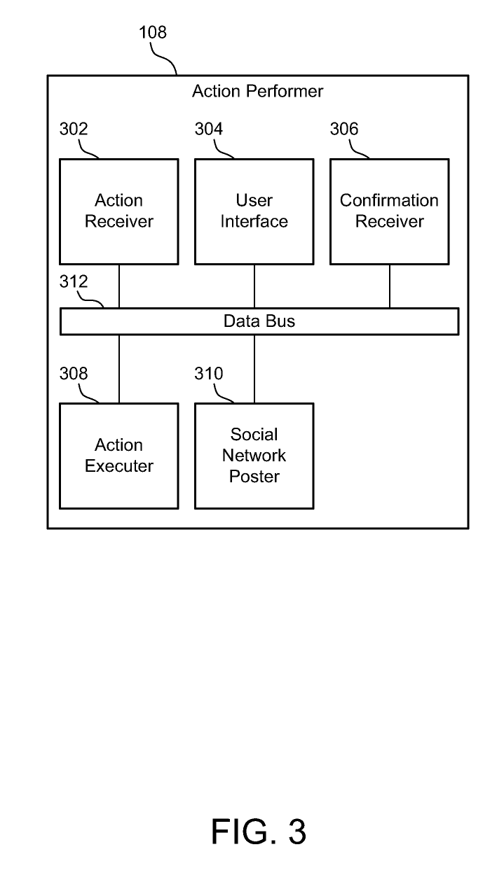

The action performer 108, in one embodiment, performs one or more actions determined by the script manager 106. The actions performed by the action performer 108 may include actions on a web interface instance and posting activity on a web interface instance, such as a social networking web interface instance. In some embodiments, the action performer 108 receives confirmation from a user to perform an action. The action performer 108 is described in greater detail in relation to FIG. 3.

FIG. 2 depicts a schematic diagram of one embodiment of the script manager 106 of FIG. 1. The script manager 106 includes a target web interface instance determiner 202, a script pairing engine 204, an action pairing engine 206, a likely action selector 208, an action recorder 210, a script submitter 212, a markup manager 214, and a data bus 216. The script manager manages generation and/or modification of a script that operates on a web interface instance.

The target web interface instance determiner 202, in one embodiment, determines a target web interface instance for operation of a script. The target web interface instance may be transmitted to the target web interface instance determiner 202 by the task description receiver 104. In an alternative embodiment, the target web interface instance determiner 202 determines a target web interface instance based on the task description. For example, if the task description is to purchase a ticket on a particular airline, the target web interface instance determiner 202 may submit the name of the particular airline to a search engine to determine the target web interface instance.

In another embodiment, a script may exist in the script repository to operate on a particular web interface instance, and the target web interface instance determiner 202 may determine that the particular web interface instance has changed since the script was last executed. The target web interface instance determiner may select the particular web interface instance that has changed as the target web interface instance. By selecting the modified web interface instance as the target web interface instance, the system 100 can modify a script to operate on the modified web interface instance.

The script manager 106, in one embodiment, includes several mechanisms for generating a script. One mechanism is pairing the task description with one or more scripts in the script repository 102 to determine actions to execute the task. Other mechanisms may include analyzing the target web interface instance to determine appropriate actions which may or may not appear in a script in the script repository 102. The script manager 106 may generate a script using actions from a combination of scripts in the script repository 102 and/or actions not appearing in scripts in the script repository 102. The script generated by the script manager 106 may include actions retrieved from scripts in the script repository 102 and/or actions determined to be available on the target web interface instance.

The script pairing engine 204, in some embodiments, pairs the task description with one or more scripts from the script repository 102. In some embodiments, the script pairing engine 204 pairs more than one script from the script repository 102 with the task description. The scripts and the task description may be paired based on similar terms in a description associated with the script and the task description. For example, the task description may be to check a price of a particular item on a particular merchant web interface instance. The task description may be paired with a script in the script repository that includes an associated description that describes checking the price of a different item at the particular merchant web interface instance.

In some embodiments, the script pairing engine 204 attempts to locate the script having a description that most closely matches the task description. For example, the script pairing engine 204 may compare the task description to the all of the descriptions associated with the scripts in the script repository 102. In another example, the script pairing engine 204 may compare the task description with an index that indexes all of the descriptions associated with the scripts in the script repository 102.

In an alternative embodiment, the script pairing engine 204 uses a subset of the scripts in the script repository 102 to select a script to pair with the task description. The script pairing engine 204 may use a probabilistic method to compare the task description to a certain percentage of script descriptions chosen at random. In another embodiment, the script pairing engine 204 generates a numerical measure that describes the similarity between the task description and the script description, and if the similarity between the script description and the task description is greater than a threshold value, the script pairing engine 204 pairs the script associated with the script description with the task description.

In some embodiments, the script pairing engine 204 uses a history of recorded user actions to pair the task description with a script from the script repository 102. For example, a frequently used script may be weighted to increase the probability that it will be paired with the task description.

The action pairing engine 206, in one embodiment, pairs an action from the paired script with an action available on the target web interface instance. The action paring engine 206 may use any method of determining which action on the target web interface instance to pair with an action from the paired script. In some embodiments, the action pairing engine pairs the actions based on text similarity of the actions, and an action on the target web interface instance that includes text most similar to text in the action included in the paired script is paired with the action included in the paired script.

In another embodiment, the action pairing engine 206 uses a history of recorded actions of a user to select an action on the target web interface instance to pair with the action included in the paired script. For example, a history of recorded actions may indicate that a user frequently selects a particular action on the target web interface instance, and the action pairing engine 206 may weight the particular action to increase the probability that it will be paired with the action included in the paired script.

The likely action selector 208, in one embodiment, attempts to predict the action on the target web interface instance that should be selected next to accomplish the task described by the task description. In some embodiments, the likely action selector 208 uses a machine learning model to predict the action. The machine learning model is trained using any input that can improve the accuracy of the model. For example, the machine learning model may be trained using one or more of the text of the task description, a history of recorded user actions, and the descriptions associated with scripts in the script repository 102. In some embodiments, the likely action selector 208 selects the next unpaired action from the paired script as the action most likely to be selected.

The action recorder 210, in one embodiment, records actions performed to generate a script. The actions recorded by the action recorder 210 may be actions selected by the likely action selector 208. For example, the system 100 may generate actions to perform on a target web interface instance by using a script designed for a different web interface instance to perform a task. In this example, the action recorder 210 records actions as they are performed on the target web interface instance. The recorded actions make up a script that may be used in the future to perform the task on the target web interface instance.

Actions recorded by the action recorder 210, in some embodiments, include a text form representation of web actions. The recorded actions may also include text of the web page open when the action occurred. The action recorder 210 may also record a screenshot of the web page open when the action occurred. Other metadata may also be recorded by the action recorder 210, such as a user name and a time stamp.

In certain embodiments, the action recorder 210 records actions by a user as the user accesses one or more webpages. The action recorder 210 may be configured to always record actions, or the action recorder 210 may be turned on and off. In one embodiment, the action recorder 210 records actions by a user to a buffer, and discards the oldest actions when the buffer is full. The recorded actions may be browsed by a user. In some embodiments, recorded actions may be posted to a social networking site. Posting actions to a social networking site is described in greater detail in relation to FIG. 3.

In some embodiments, the script generated by the action recorder 210 is submitted by the script submitter 212 to the script repository 102. The script submitter 212 may include the task description with the script. The script submitted to the script repository 102 may be used by the system 100 to generate and/or modify other scripts.

The markup manager 214, in some embodiments, manages markup to a script in the script repository 102. The markup may be a hidden markup not generally visible to users of the script. For example, a script user may see the script alone unless a menu option is selected by the user to view the hidden markup.

In some embodiments, the markup managed by the markup manager 214 is in a language that can be operated upon by other computer components. For example, the markup may be in a semantic markup language, such as microformat. In this example, microformat markup may be used by other computer components to extract information about the script associated with the markup, such as authorship data, associated target web interface instances, and/or dates created and/or executed.

The data bus 216 provides a communication pathway within the script manager 106 for various elements of the script manager 106. The data bus 216 may be any type of data communication system, including, but not limited to, a hardware bus, a wired connection, a network, a mesh system, and a wireless communication system. In some embodiments, the data bus 216 may include a combination of types of data communication system.

FIG. 3 depicts a schematic diagram of one embodiment of the action performer 108 of FIG. 1. The action performer 108 includes an action receiver 302, a user interface 304, a confirmation receiver 306, an action executer 308, a social network poster 310, and a data bus 312. The action performer 108 performs actions on a web interface instance under the direction of the script manager 106 and/or a user.

In one embodiment, the action receiver 302 receives an action to be performed from the script manager 106. The received action to be performed may be an action to be performed on a web interface instance. The received action may be any action that can be performed on a web interface instance. For example, the received action may be clicking on a link, entering text into a field, or another action.

The user interface 304, in one embodiment, provides a method for communication between the action performer 108 and a user. The user interface 304 may receive input from a user that directs the action performer 108. In some embodiments, the user interface 304 communicates an action that may be performed to the user. For example, the user interface 304 may communicate an action that has been selected as the most likely next action to perform a task to a display (not shown) which displays the action to the user.

In some embodiments, the confirmation receiver 306 receives a confirmation from a user that a predicted next action is the correct next action. For example, the user interface 304 may communicate an action that has been selected as the most likely next action to a user and prompt the user for confirmation. If the user confirms the action, the user interface 304 communicates the confirmation to the confirmation receiver 306.

In some embodiments, if the user indicates that the action should not be performed, the confirmation receiver 306 indicates to the script manager 106 that the action should not be performed or included in the generated script. In some embodiments, the script manager 106 communicates a next most likely action to be performed to the action performer 108 if the user indicates that the most likely action should not be performed.

The action executer 308, in one embodiment, executes the action on the web interface instance. For example, the confirmation receiver 306 may receive an indication from a user that an action should be performed. In this example, the action executer 308 executes the action on the web interface instance. Execution of the action may result in any outcome that an action on a web interface instance can cause. For example, execution of the action may result in submission of data, selection of link, or proceeding to another web interface instance. Proceeding to another web interface instance may be the result of selection of a link on the web interface instance. Proceeding to another web interface instance may also be the result of any other action on the web interface instance.

In some embodiments, the social network poster 310 posts a representation of actions recorded by the action recorder 210 to a social network. The representations of the actions may include captured text, a textual representation of web actions, screen shots, a timestamp, or any other recorded action. In some embodiments, the representation of actions presents the actions in the chronological order in which they occurred.

In one embodiment, the action posted by the social network poster 310 includes a screenshot associated with the web action. In another embodiment, the social network poster 310 posts a task description along with the representation of the actions recorded by the task recorder 210.

The social network to which the representation of actions is posted may be any type of social network. For example, the social network may be a social structure of individuals and/or organizations, email, instant messaging, wikis, blogs, video sharing, and/or collaborative tagging and subject indexing.

The social network poster 310, in one embodiment, receives input from the user interface 304 to select a portion of the recorded actions recorded by the task recorder 210. The user interface 304 may include a method for searching for a keyword in the recorded actions to locate a portion of the recorded actions.

In some embodiments, the social network poster 310 receives input from the user interface to edit recorded actions before they are posted. For example, the user interface may allow a user to delete or obscure a portion of the text associated with an action, such as a credit card number. By allowing a user to submit input indicating which portion of actions should be posted and/or to edit the recorded actions, the social network poster 310 allows a user to determine which portion of the representation of recorded web browser activity is to be shared.

The data bus 312 provides a communication pathway within the action performer 108 for various elements of the action performer 108. The data bus 312 may be any type of data communication system, including, but not limited to, a hardware bus, a wired connection, a network, a mesh system, and a wireless communication system. In some embodiments, the data bus 312 may include a combination of types of data communication system.

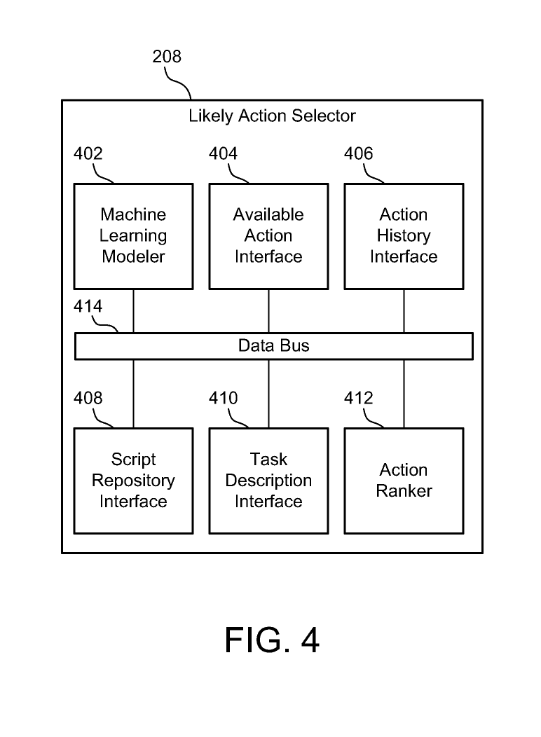

FIG. 4 depicts a schematic diagram of one embodiment of the likely action selector 208 of FIG. 2. The likely action selector 208 includes a machine learning modeler 402, an available action interface 404, an action history interface 406, a script repository interface 408, a task description interface 410, an action ranker 412, and a data bus 414. The likely action selector 208 selects an action as most likely to be selected to complete a task.

The machine learning modeler 402, in one embodiment, analyzes data to predict the likelihood that an action will be selected. The data analyzed by the machine learning modeler 402 may include available actions on the target web interface instance, a history of recorded user actions, data associated with existing scripts for performing actions on web interface instances, and a task description. The machine learning modeler 402 generates a score for available actions on the target web interface instance based on a probabilistic algorithm that models the likelihood that an action will help complete the task described in the task description.

In one embodiment, the available action interface 404 provides the machine learning modeler 402 data relating to actions available on the target web interface instance. The available action interface 404 receives a reference to the target web interface instance from the target web interface instance determiner 202. The available action interface 404 analyzes the target web interface instance and presents a list of all actions available on the target web interface instance.

The action history interface 406, in one embodiment, provides the machine learning modeler 402 with data relating to actions previously taken by a user. The action history interface 406 receives historical data recorded by the action recorder 210. In some embodiments, the action history interface 406 continually provides history data to the machine learning modeler 402, and the machine learning modeler 402 uses the history data to suggest likely future actions to the user based on previous actions of the user.

In one embodiment, the script repository interface 408 provides the machine learning modeler 402 with data relating to previously generated scripts. The script repository interface 408 accesses the script repository 102 to access previously generated scripts. The script data provided by the script repository interface 408 may include any data associated with scripts, such as text, metadata, and statistical information.

The task description interface 410, in one embodiment, provides the machine learning modeler 402 with data relating to the task description. The task description is received via the task description receiver 104. The task description is used by the machine learning modeler 402 to indicate the task that should be achieved by suggested actions.

The action ranker 412 ranks actions in order of their predicted likelihood of advancing the task. The machine learning modeler 402 assigns a numerical score to available actions, and the action ranker 412 ranks the score in order of the numerical scores. In some embodiments, the action ranked by the action ranker 412 as the most likely action is provided to the action performer 108. If the confirmation receiver 306 receives an indication that the most likely action should not be performed, the action ranker 412 provides the next most likely action to the action performer 108.

The data bus 414 provides a communication pathway within the likely action selector 208 for various elements of the likely action selector 208. The data bus 414 may be any type of data communication system, including, but not limited to, a hardware bus, a wired connection, a network, a mesh system, and a wireless communication system. In some embodiments, the data bus 414 may include a combination of types of data communication system.

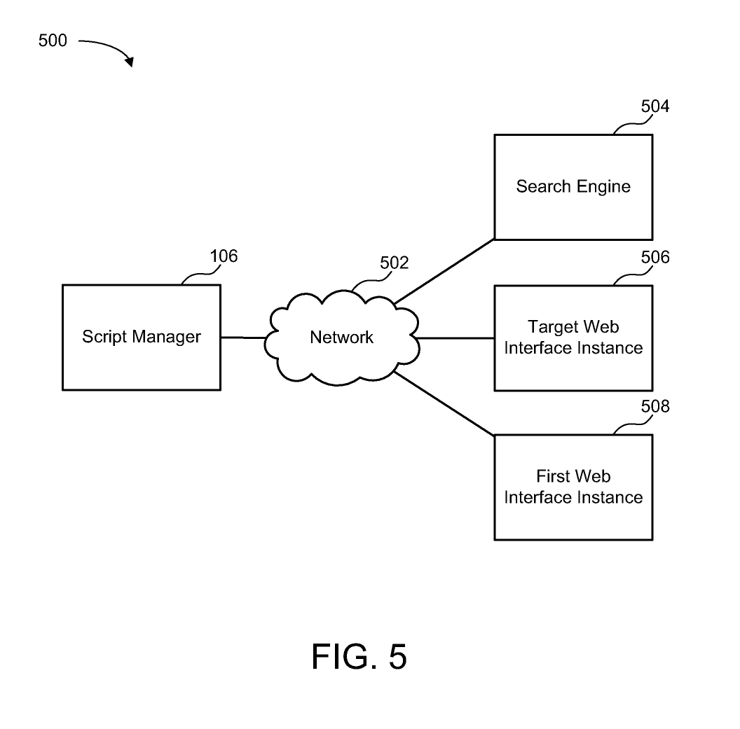

FIG. 5 depicts a schematic diagram of one embodiment of a system 500 for determining likely actions on a target web interface instance 506. The system 500 includes the script manager 106, a network 502, a search engine 504, the target web interface instance 506, and a first web interface instance 508. The system 500 analyzes a task and modifies an existing script to complete the task. The script manager 106 is similar to the same numbered element described in relation to FIGS. 1 and 2.

The network 502, in one embodiment, provides a communication pathway between elements of the system 500. The network 502 may be any type of data communication system capable of providing a communication pathway between elements of the system 500. For example, the network 502 may be an Ethernet based network, a wireless connection, a fiber network, or any combination of network types. In one embodiment, the network 502 includes the Internet.

The search engine 502 provides a reference to a web interface instance based on an input of data. The system 500 uses the search engine 502 to predict a target web interface instance 506 to complete a task. For example, the target web interface instance determiner 202 may submit text from a task description to the search engine 504. In this example, the search engine 504 determines a web interface instance that most closely corresponds to the task description based on a ranking algorithm and provides a reference to that web interface instance to the target web interface instance determiner 202.

The target web interface instance 506, in one embodiment, is determined by the target web interface instance determiner 202 as a web interface instance that may be used to complete the task described in the task description. The script manager 106 communicates with the target web interface instance 506 to determine available actions on the target web interface instance, pair the available actions with actions in an existing script, and predict the available action most likely to lead to completion of the task.

In some embodiments, the action performer 108 performs an action on the target web interface instance 506. The performed action may result in accessing a first web interface instance 508 separate from the target web interface instance 506. A reference to the first web interface instance 508 may be submitted to the target web interface instance determiner 202 as a new target web interface instance.

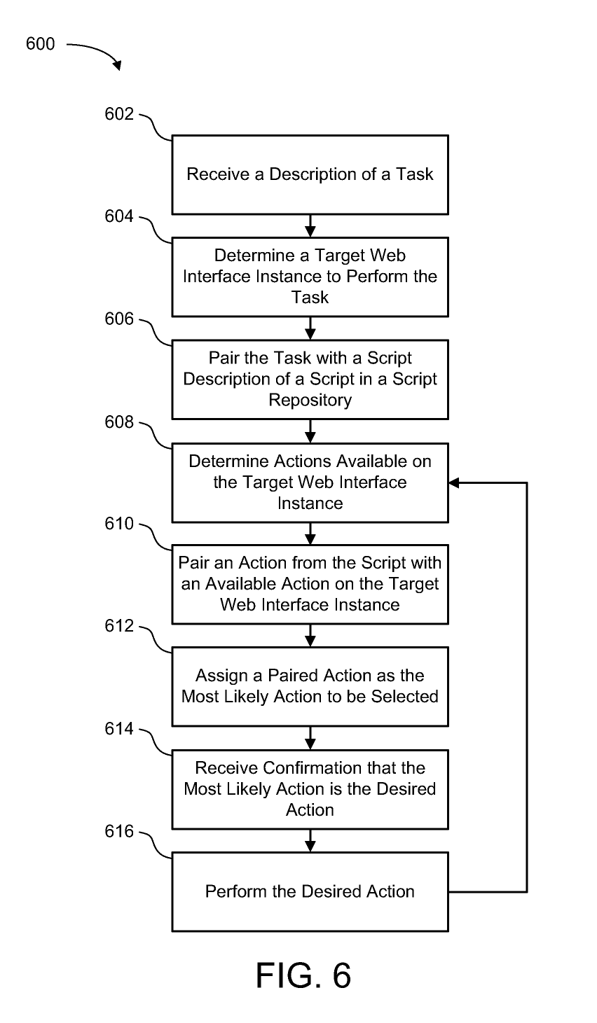

FIG. 6 is a flow chart diagram depicting one embodiment of a method 600 for modifying a script that operates on one web interface instance to operate on another web interface instance. The task description receiver 104 receives 602 a description of a task to be performed. The target web interface instance determiner 202 uses the task description to determine 604 a target web interface instance 506 for performing actions related to the task. The target web interface instance determiner 202 may access a search engine 504 to determine 604 the target web interface instance 506.

The task is paired 606 with a script description of a script in the script repository 102 by the script pairing engine 204. The task and the script may be paired 606 by determining a similarity between text in the task description and a description associated with the script.

The available action interface 404 determines 608 available actions on the target web interface instance 506. The action pairing engine 206 pairs 610 an available action with an action from the script. In some embodiments, the action pairing engine 206 pairs 610 the first unpaired action from the script with an available action. A paired action is assigned 612 as the most likely action to be selected by the likely action selector 208.

The confirmation receiver 306 receives 614 confirmation that the most likely action is the desired action, and the action executer 308 performs 616 the desired action. Performance 616 of the desired action may result in selection of a new target web interface instance. The method 600 returns to determine 608 actions available on the new target web interface instance if the task is not yet complete.

It should also be noted that at least some of the operations for the methods may be implemented using software instructions stored on a computer useable storage medium for execution by a computer. As an example, an embodiment of a computer program product for automatically generating a script for a target web interface instance includes a computer useable storage medium to store a computer readable program that, when executed on a computer, causes the computer to perform operations, including receiving a task description of a task to be completed on a target web interface instance. The operations also include repeating steps until the task is completed. The repeating steps include determining from the target web interface instance a plurality of actions that may be performed on the target web interface instance and pairing the task description with a description of a script in a repository of existing scripts. The repeating steps also include pairing an action from the script with an action that may be performed on the target web interface instance and assigning the paired action that may be performed on the target web interface instance as an action most likely to be selected. The repeating steps also include performing the action most likely to be selected, thus proceeding to a first web interface instance, and setting the first web interface instance as the target web interface instance.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for automatically generating a script for a target web interface instance, comprising:
receiving a task description of a task to be completed on a target web interface instance; and
repeating until the task is completed:
determining from the target web interface instance a plurality of actions that may be performed on the target web interface instance;
using the task description, predicting which action of the plurality of actions from the target web interface instance is an action most likely to be selected;
performing the action most likely to be selected, thus proceeding to a first web interface instance; and
setting the first web interface instance as the target web interface instance.

2. The computer-implemented method of claim 1, further comprising:
creating a machine learning model to predict the action most likely to be selected, wherein:
the machine learning model is trained using:
the task description,
a history of recorded user actions, and
a repository of existing scripts that are related to the task; and
predicting which action is most likely to be selected by the machine learning model.

3. The computer-implemented method of claim 2, wherein the task description and the history of recorded user actions are used to access relevant existing scripts.

4. The computer-implemented method of claim 2, wherein:
the task description is paired with a description of a script in the repository of existing scripts;
an action from the script is paired with an action that may be performed on the target web interface instance; and
assigning the paired action that may be performed on the target web interface instance as the action most likely to be selected.

5. The computer-implemented method of claim 4, further comprising presenting a paired script from the repository of existing scripts to a user for confirmation.

6. The computer-implemented method of claim 2, wherein:
the repository of existing scripts comprises a script for a previous version of a web interface instance;
the previous version of the web interface instance has been modified to form a new version of the web interface instance;
the target web interface instance is set as the new version of the web interface instance; and
the machine learning model is trained using the script for the previous version of the web interface instance.

7. The computer-implemented method of claim 1, further comprising creating a script for the target web interface instance from the actions performed in completing the task on the target web interface instance.

8. The computer-implemented method of claim 7, further comprising storing the created script in the repository of existing scripts.

9. The computer-implemented method of claim 1, wherein each action is presented to a user for confirmation in response to determining an action most likely to be selected.

10. The computer-implemented method of claim 9, wherein an action next most likely to be selected is presented to the user for confirmation in response to receiving an indication from the user that the action most likely to be selected should not be selected.

11. The computer-implemented method of claim 1, further comprising:
observing browser activity from a user surfing the web;
capturing in text form web actions of the browser activity, text of the web page open when a captured web action occurred, timestamp, and a screenshot of the web page open;
creating a representation of the recorded browser activity, comprising a chronological order of the text form of web actions;
determining which portion of the representation of the recorded browser activity is to be shared; and
sending the determined portion of the representation for posting.

12. The computer-implemented method of claim 11, further comprising posting the determined portion of the representation on a social networking site.

13. The computer-implemented method of claim 12, wherein the social networking site comprises an at least one collaboration mechanism from the group consisting of:
social structures of individuals and organizations;
emails;
instant messaging;
wikis;
blogs;
video sharing; and
collaborative tagging and subject indexing.

14. The computer-implemented method of claim 11, wherein creating the representation further comprises including the screenshot associated with the web action.

15. The computer-implemented method of claim 14, further comprising searching using a keyword search for a previous action in the representation.

16. A computer program product comprising a computer useable storage medium to store a computer readable program, wherein the computer readable program, when executed on a computer, causes the computer to perform operations for automatically generating a script for a target web interface instance, the operations comprising:
receiving a task description of a task to be completed on a target web interface instance; and
repeating until the task is completed:
determining from the target web interface instance a plurality of actions that may be performed on the target web interface instance;
pairing the task description with a description of a script in a repository of existing scripts;
pairing an action from the script with an action that may be performed on the target web interface instance;
assigning the paired action that may be performed on the target web interface instance as an action most likely to be selected;
performing the action most likely to be selected, thus proceeding to a first web interface instance; and
setting the first web interface instance as the target web interface instance.

17. The computer program product of claim 16, further comprising selecting the target web interface instance by querying a search engine with the task description.

18. The computer program product of claim 16, wherein the action from the script is a first unpaired action in the script.

19. A system comprising:
a script repository to store a plurality of scripts, each script to perform a task on a web interface instance;
a task description receiver to receive a task description of a task to be performed;
a script generator to:
determine a target web interface instance for the task; and
repeat until the task is completed:
determine from the target web interface instance a plurality of actions that may be performed on the target web interface instance;
using the task description, predict which action of the plurality of actions from the target web interface instance is most likely to be selected;
submit the action to an action performer to perform the action most likely to be selected, thus proceeding to a first web interface instance; and
set the first web interface instance as the target web interface instance; and
the action performer to perform an action submitted by the script generator.

20. The system of claim 19, wherein the target web interface instance comprises at least one interface mechanism selected from the group consisting of:
a website;
a web page;
an online application; and
an embedded program.
